(19) United States
(12) Patent Application Publication
(10) Pub. No.: US 2025/0269749 A1
(43) Pub. Date: Aug. 28, 2025

(54) SYSTEM AND METHOD FOR SUPERCHARGING ELECTRIC VEHICLES

(71) Applicant: Electronic Power Design, Inc., Houton, TX (US)

(72) Inventor: JOHN BRADFORD JANIK, Houston, TX (US)

(73) Assignee: Electronic Power Design, Inc., HOUSTON, TX (US)

(21) Appl. No.: 19/012,186

(22) Filed: Jan. 7, 2025

Related U.S. Application Data
(60) Provisional application No. 63/618,403, filed on Jan. 8, 2024.

(51) Int. Cl. B60L 53/53; B60L 53/64; B60L 53/67

(52) U.S. Cl. CPC B60L 53/53; B60L 53/64; B60L 53/67

(57) ABSTRACT

A buried large bulk battery, which is a significant component of the charging station's infrastructure that serves as a power source for charging electric vehicles. The proposed system and method provide a novel approach to optimizing EV charging station operations by leveraging linear programming and bulk battery storage. This invention addresses the challenges of grid demand, cost management, and renewable energy integration, offering a scalable and sustainable solution for the growing EV market.

This patent application takes priority from U.S. patent application Ser. No. 63/618,403 filed on Jan. 8, 2024 by Janik and entitled, “A SYSTEM AND METHOD FOR CHARGING ELECTRIC VEHICLES UTILIZING A BURIED BULK BATTERY CHARGING SYSTEM,” which hereby incorporated by reference herein in its entirety; this patent application also claims priority from U.S. Provisional Patent Application No. 62/286,705 by John B. Janik, entitled “System and Method for Charging management Using Linear Programming”, filed on Jan. 25, 2016; this patent application also claims priority from U.S. Provisional Patent Application No. 62/286,705 by John B. Janik, entitled “System and Method for Charging management Using Linear Programming”, filed on Jan. 25, 2016; and this patent application also claims priority from U.S. Provisional Patent Application No. 62/286,705 by John B. Janik, entitled “System and Method for Charging management Using Linear Programming”, filed on Jan. 25, 2016

### BACKGROUND OF THE INVENTION

As electric vehicles increase in usage there is a need for an efficient electric vehicle charging system.

### FIELD OF THE INVENTION

The present invention relates to the field of charging electric vehicles.

### BRIEF DESCRIPTION OF THE DRAWINGS

FIG. 1 is a schematic depiction of an illustrative embodiment of the invention showing a system and method for charging electric vehicles utilizing a buried bulk battery charging using linear programming for charging management.

### SUMMARY OF THE INVENTION

The invention features a buried large bulk battery, using linear programming for charging charging management. This battery serves as a power source for charging electric vehicles (EVs).

### DETAILED DESCRIPTION OF THE INVENTION

The present invention discloses buried batteries for charging stations to charge an electric vehicle using linear programming has the following features, Buried Large Bulk Battery: The invention features a buried large bulk battery, which is a significant component of the charging station's infrastructure. This battery serves as a power source for charging electric vehicles (EVs). Optimized Charging Time: The primary goal of this invention is to optimize the charging time for electric vehicles. By using a buried battery, it enables efficient charging that doesn't solely rely on the utility line. This optimization can significantly reduce the time required to charge an EV. Trickle Charging Capability: The buried battery has the capability to perform trickle charging. Trickle charging is a slow and steady method that ensures the battery is charged to its maximum capacity without overloading it. This feature is useful for prolonging the battery life of the electric vehicle. Utilization of Utility Line: The charging station does not solely depend on the utility line for charging. While it can still utilize the utility line, the presence of the buried battery ensures that the charging process is not restricted by the availability or limitations of the utility line. This helps in addressing potential power grid constraints. Time of Day Charging Optimization: The invention allows for time of day charging optimization. This means that the charging station can be programmed to take advantage of off-peak hours when electricity rates are lower, thereby reducing the cost of charging an electric vehicle.

Charging Rates for EV Supercharging: The technology can support fast and efficient supercharging for electric vehicles. This is crucial for EV owners who need a rapid charge, such as those traveling long distances. The buried battery ensures that the charging station can deliver high power output for supercharging.

Energy Efficiency: The presence of the buried battery contributes to the overall energy efficiency of the charging station. It can store excess energy during off-peak hours and release it when needed for charging, reducing energy waste and grid congestion. Environmental Benefits: By enabling efficient and fast charging, this invention can potentially reduce the waiting times at charging stations, promoting the adoption of electric vehicles and reducing emissions from traditional gas-powered vehicles. Cost Savings: The ability to optimize charging times and rates, as well as the reduced reliance on the utility line, can lead to cost savings for both EV owners and charging station operators. Scalability: The concept of buried batteries is scalable, making it adaptable for various sizes and types of charging stations, from small residential setups to large public charging networks.

Advantages include but are not limited to the buried batteries in the ground not only decreases their weight but also effectively dissipates the heat they generate; and introduces a range of features aimed at enhancing the efficiency, cost-effectiveness, and environmental benefits of electric vehicle charging. The utilization of buried batteries represents a novel approach to address the unique challenges associated with EV charging

In a particular illustrative embodiment, a controller with a processor and non-transitory computer readable medium, having a linear programming computer program stored in the non-transitory computer readable medium, is provided for controlling the use of utility power, trickle charging, time of day charging and vehicle charging stations for energy for management of supplying energy to a system load created by electric vehicle charging stations. The linear programming determines a current system load presented by the charging stations being serviced by utility power, trickle charging, time of day charging and determines a charging profile for the bulk battery using the utility power, trickle charging, time of day charging. The linear programming system adjusts the usage of each of the utility power, trickle charging, time of day charging for economically servicing the system load. The linear programming system adjusts the usage of each of the utility power, trickle charging, time of day charging for servicing the system load. A method is disclosed for using the linear programming charging management system to effieciently utilize the utility power, trickle charging, time of day charging to service the system load.

A tutorial and description of the use of linear programming that can be adapted and used in one particular embodiment of the present invention is described in the book Linear programming, by Vasek Chvatal, W. H. Freeman and Company, New York, 1983.

The present invention includes but is not limited to a fast-charging system of an electric vehicle that includes a ground-fast charging interface and an energy storage station for storing energy battery pack. Fast-charging system for electric vehicles provides a ground-fast charging interface and an underground energy-storage station. The energy storage station is a battery pack that can be directly connected to two storage batteries which can be charged and discharged repeatedly in parallel or in series. The external electric energy is stored to a predetermined power through trickle charging and is then used to charge the electric vehicle via the ground fast charging interface. The energy storing station is the source of charging energy for the ground fast charging interface. The ground quick charge interface is used to charge a large number of electric vehicles, battery-operated motorcycles, electric sedans, electronic mini-bus, and electronic big buses.

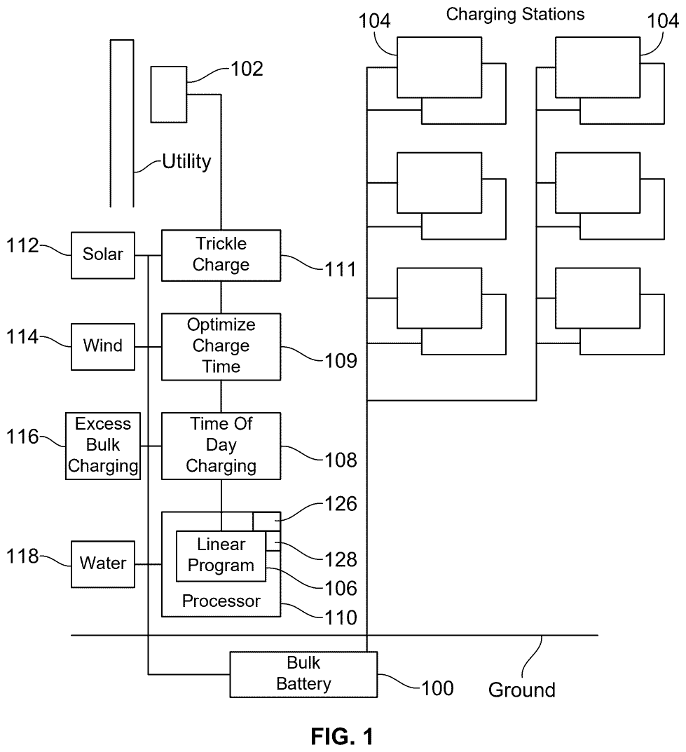

Turning now to FIG. 1, as shown in FIG. 1, a particular illustrative embodiment of the invention includes but is not limited to a bulk battery 100, an electrical utility power grid power supply 102 and charging stations 104. The bulk battery is charged using power input from utility 102, a solar electrical power source 112, wind generated electrical power source 114, excess bulk battery charge module 116, water generated electrical power source 118, a utility trickle charger 111, an optimized charge time module 109, time of day charger 108 and a linear program 106.

The present invention provides a controller having a “Linear Algebra” (also referred to as herein as “Linear” and “Linear Programming”) computer program stored in a non-transitory computer readable medium, wherein the Linear Algebra, or the solutions to simultaneous non-equalities, to yield substantially improved efficiency and substantially least efficiency solutions to active EV charging management. In an illustrative embodiment of the invention a system and method provides a substantially most efficient use of solar power, the charging of stored energy devices, the discharging of stored energy devices, engine generator power, utility power and total and partial energy consumption and management.

A tutorial and description of the use of linear programming that can be adapted and used in one particular illustrative embodiment of the present invention is described in the book Linear programming, by Vasek Chvatal, W. H. Freeman and Company, New York, 1983. An example of how to use of using linear programming to find an optimal fuel mixture for each generator at each time period and under each scenario using linear programming; and repeating the previous two steps as long as the fuel mixture obtained from the linear programming solution changes is shown in U.S. Pat. No. 6,021,402 to Takriti, which is hereby incorporated herein by reference in its entirety. An example of an charging management system that uses an expert system as an charging management system uses an expert engine and a numerical solver to determine an optimal manner of using and controlling the various energy consumption, producing and storage equipment in a plant/communities in order to for example reduce energy costs within the plant, and is especially applicable to plants that require or that are capable of using and/or producing different types of energy at different times. The charging management system operates the various energy manufacturing and energy usage components of the plant to minimize the cost of energy over time, or at various different times, while still meeting certain constraints or requirements within the operational system, such as producing a certain amount of heat or cooling, a certain power level, a certain level of production, etc. in U.S. Pat. No. 9,335,748 to Francino, which is hereby incorporated herein by reference in its entirety. In another particular illustrative embodiment of the invention, the CMC processor of the present invention is programmed as an expert system to perform charging management as described herein. In another particular illustrative embodiment of the invention, the CMC processor of the present invention is programmed as a neural network to perform charging management as described herein.

Turning now to FIG. 1, FIG. 1 depicts a particular illustrative embodiment of the invention as a system provided using a computer program for charging management. The computer program is a linear program. In another illustrative embodiment, the computer program can be but is not limited to a neural network and an expert system. These illustrative embodiments of systems in the present invention are controlled by a processor using linear programming to achieve a high efficiency of use between the bulk battery, EV charging stations and energy sources. In another embodiment a neural network is used to achieve high efficiency of use between the between the bulk battery, EV charging stations and energy sources.

In a particular embodiment of the invention, the CMC processor processing uses Linear Programming stored as computer program 126 on computer readable medium 128 to read a current operating state for the between the bulk battery, EV charging stations and energy sources and determines a substantially optimally efficient operating state for efficiently producing energy to charge the bulk battery and supply energy to EV charging stations at the current time. The operating state for batteries includes but is not limited to percent charged to capacity, type of battery and plot point on a battery life to power output capacity curve for each battery type used in the system. The charging management control (CMC) Processor achieves a substantially efficient charging by using a linear programming computer program stored on a computer readable medium to efficiently use charging energy between the bulk battery, EV charging stations and energy sources to provide charging of the bulk battery and vehicles being charged at the EV charging stations at a substantially reduced cost.

In another particular illustrative embodiment of the invention, a computer program is provided in the non-transitory computer readable medium attached to the CMC processor. The computer program includes but is not limited to computer instructions stored in a computer readable medium that when executed by the load management processor, perform functions that are useful in accomplishing charging between the bulk battery, EV charging stations and energy sources. In another embodiment, the computer program includes but is not limited to instructions that use linear algebra to manage the charging of the bulk battery and the EV at the charging stations.

Computer program 126 including but not limited to computer instructions stored in a Computer Readable Medium 128 are executed by the CMC processor 110.

In another particular illustrative embodiment, a neural network is provided as a computer program in the computer readable medium that is executed by the CMC processor to monitor the operating states of the batteries, engines and generator discussed above and energy supplied to the equipment during operations of raising and lowering jack up rig legs and punch through testing and tension and torque applied to the anchor cable and winch during successful anchor setting operations. The neural network monitors the operating states for of all energy sources during the operations and stores them in the computer readable medium. The neural network stores the monitored operating states of the batteries, engines and generators discussed above and provided in the EV charging System which charges the bulk battery and the EV charging stations while charging EVs.

In another particular illustrative embodiment of the invention the computer program is a linear program. In another particular illustrative embodiment of the invention the computer program is an expert system. In another particular illustrative embodiment of the invention the computer program is a neural network.

In another particular illustrative embodiment of the invention the operating state comprises a load on the battery. In another particular illustrative embodiment of the invention the computer program is a linear program. In another particular illustrative embodiment of the invention the computer program is an expert system. In another particular illustrative embodiment of the invention the computer program is a neural network.

In another particular illustrative embodiment of the invention a computer readable medium is disclosed containing instructions that are executed a processor in data communication with a non-transitory computer readable medium to control a EV charging system hybrid power source for servicing a system load, the hybrid power source comprising a natural gas engine, a diesel engine and a battery, the computer program comprising instructions stored in the non-transitory computer readable medium that are executed by the processor, the computer program including but not limited to instructions to cause the load processor to determine a current system load serviced by power provided from the hybrid power source; instructions for the processor to determine a current operating state for the natural gas engine, the diesel engine and the battery; instructions for the processor to use linear programming to determine a new operating state for the natural gas engine, the diesel engine and the battery to reduce power consumption servicing the current system load the natural gas engine, the diesel engine and the battery; and instructions for the processor to replace the current operating state for the natural gas engine, the diesel engine and the battery to the new operating state for the natural gas engine, the diesel engine and the battery. In another particular illustrative embodiment of the invention in the computer readable medium, the operating state comprises a load on the diesel engine, speed of the diesel engine and air fuel mixture supplied to the diesel engine, wherein the operating state further comprises torque of the diesel engine. In another particular illustrative embodiment of the invention in the computer readable medium, the operating state comprises a load on the natural gas engine, speed of the natural gas engine and air fuel mixture supplied to the natural gas engine, wherein the operating state further comprises torque of the natural gas engine. In another particular illustrative embodiment of the invention in the computer readable medium, the operating state comprises a load on the battery. In another particular illustrative embodiment of the invention in the computer readable medium, the computer program is a linear program. In another particular illustrative embodiment of the invention in the computer readable medium, the computer program is an expert system.

The present invention can be realized in hardware, software, or a combination of hardware and software. In a specific embodiment, a system according to the present inventions can be realized in a centralized fashion in one computer system, or in a distributed fashion where different elements are spread across several interconnected computer systems. Any kind of computer system or other apparatus adapted for carrying out the methods and inventions described herein may be used for purposes of the present inventions. A typical combination of hardware and software could be a general purpose computer system with a computer program that, when loaded and executed, controls the computer system such that it carries out the methods and inventions described herein.

The figures herein include block diagram and flowchart illustrations of methods, apparatus(s) and computer program products according to various embodiments of the present inventions. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus may be used to implement the functions specified in the block, blocks or flow charts. These computer program instructions may also be stored in a computer-readable medium or memory that can direct a computer or other programmable data processing apparatus to function in a particular manner, such that the instructions stored in the computer-readable medium or memory produce an article of manufacture including instructions which may implement the function specified in the block, blocks or flow charts. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block, blocks or flow charts.

Those skilled in the art should readily appreciate that programs defining the functions of the present inventions can be delivered to a computer in many forms, including but not limited to: (a) information permanently stored on non-writable storage media (e.g., read only memory devices within a computer such as ROM or CD-ROM disks readable by a computer 1/0 attachment); (b) information alterably stored on writable storage media (e.g., floppy disks and hard drives); or (c) information conveyed to a computer through communication media for example using wireless, baseband signaling or broadband signaling techniques, including carrier wave signaling techniques, such as over computer or telephone networks via a modem, or via any of networks.

The term “executable” as used herein means that a program file is of the type that may be run by the CMC processor 110. In specific embodiments, examples of executable programs may include without limitation: a compiled program that can be translated into machine code in a format that can be loaded into a random access portion of the Computer Readable Medium 128 and run by the CMC processor 110; source code that may be expressed in proper format such as object code that is capable of being loaded into a random access portion of the Computer Readable Medium 128 and executed by the CMC processor 110; or source code that may be interpreted by another executable program to generate instructions in a random access portion of the Computer Readable Medium to be executed by the CMC processor 110. An executable program may be stored in any portion or component of the Computer Readable Medium including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The Computer Readable Medium may include both volatile and nonvolatile memory and data storage components. Volatile components are those that do not retain data values upon loss of power. Nonvolatile components are those that retain data upon a loss of power. Thus, the Computer Readable Medium may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In a specific embodiment, the CMC processor may represent multiple Load Sharing Processors and/or multiple processor cores and the Computer Readable Medium may represent multiple Computer Readable Mediums that operate in parallel processing circuits, respectively. In such a case, the local interface may be an appropriate network that facilitates communication between any two of the multiple Processors, between any processor and any of the Computer Readable Medium, or between any two of the Computer Readable Mediums, etc. The local interface may comprise additional systems designed to coordinate this communication, including, for example, performing load balancing. The CMC process may be of electrical or of some other available construction.

Although the programs and other various systems, components and functionalities described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components. Such technologies are generally well known by those skilled in the art and, consequently, are not described in detail herein.

Flowcharts and Block Diagrams of Figures I show the functionality and operation of various specific embodiments of certain aspects of the present inventions. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a CMC processor in a computer system or other system. The machine code may be converted from the source code, etc. If embodied in hardware, each block may represent a circuit or a number of interconnected circuits to implement the specified logical function(s).

Although the flowchart and block diagram of FIG. 1 show a specific order of execution, it is understood that the order of execution may differ from that which is depicted. For example, the order of execution of two or more blocks may be scrambled relative to the order shown. Also, two or more blocks shown in succession in FIG. 1 may be executed concurrently or with partial concurrence. Further, in some embodiments, one or more of the blocks shown in FIG. 1 may be skipped or omitted. In addition, any number of counters, state variables, warning semaphores, or messages might be added to the logical flow described herein, for purposes of enhanced utility, accounting, performance measurement, or providing troubleshooting aids. It is understood that all such variations are within the scope of the present inventions.

Any logic or application described herein that comprises software or code can be embodied in any non-transitory computer-readable medium, such as computer-readable medium, for use by or in connection with an instruction execution system such as, for example, a CMC processor in a computer system or other system. In this sense, the logic may comprise, for example, statements including instructions and declarations that can be fetched from the computer-readable medium and executed by the instruction execution system. In the context of the present inventions, a “computer-readable medium” may include any medium that may contain, store, or maintain the logic or application described herein for use by or in connection with the instruction execution system.

The computer-readable medium may comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

The CMC processor may further include a network interface coupled to the bus and in communication with the network. The network interface may be configured to allow data to be exchanged between computer and other devices attached to the network or any other network or between nodes of any computer system or the video system. In addition to the above description of the network, it may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, the network interface 159 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

The CMC processor may also include an input/output interface coupled to the bus and also coupled to one or more input/output devices, such as a display, a touchscreen, a mouse or other cursor control device, and/or a keyboard. In certain specific embodiments, further examples of input/output devices may include one or more display terminals, keypads, touchpads, scanning devices, voice or optical recognition devices, or any other devices suitable for entering or accessing data by one or more computers. Multiple input/output devices may be present with respect to a computer or may be distributed on various nodes of computer system, the system and/or any of the viewing or other devices shown in FIG. 1. In some embodiments, similar input/output devices may be separate from the CMC processor and may interact with the CMC processor one or more nodes of computer system through a wired or wireless connection, such as through the network interface.

It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims. None of the claim language should be interpreted pursuant to 35 U.S.C. 112 (±) unless the word “means” is recited in any of the claim language, and then only with respect to any recited “means” limitation.

System Architecture In a particular illustrative embodiment, the system comprises:
1. Electric Vehicle Charging Stations (EVCS): Equipped with charging ports of varying power levels to accommodate different types of EVs.
2. Bulk Battery Storage: Located underground, consisting of high-capacity battery modules capable of storing and discharging energy as required.
3. Charging management Controller (CMC): A computational unit responsible for real- time energy optimization using linear programming.
4. Grid Connection: Interfaces with the local energy grid for energy exchange, including trickle charge functionality to utilize off-peak hours.
5. Renewable Energy Integration: Includes solar panels, wind turbines, and hydroelectric energy sources to supplement energy supply and charge the bulk battery.

Methodology The invention employs a linear programming model to solve the optimization problem of energy allocation and scheduling. The objective is to minimize the total cost of operation while satisfying constraints related to grid capacity, battery limits, user charging demands, and renewable energy production.

### Optimization Model

Objective Function: Minimize the total cost, including electricity cost, battery degradation cost, and potential penalties for exceeding grid capacity.

Where:
Power drawn from the grid at time.
Cost per unit of electricity from the grid at time.
Battery degradation cost at time.
Cost coefficient for battery degradation.
Constraints:
   1. Demand Satisfaction: Ensure all EV charging demands are met.
   2. Grid Capacity: Power drawn from the grid must not exceed grid capacity.
   3. Battery Constraints:
      Storage limits:
      Charge/discharge rates:
   4. Renewable Energy Contribution: Use available renewable energy (solar, wind, hydroelectric) before drawing from the grid.
   5. Time-of-Day Charging: Prioritize charging during off-peak hours to leverage lower grid electricity costs.
   6. Excess Charging management: Optimize the use of excess renewable energy to charge the bulk battery during periods of high production.
   7. Excess Bulk Battery Energy Utilization: Utilize excess bulk battery energy to power EV charging stations directly, reducing dependency on grid energy during peak demand periods.

### ADVANTAGES OF THE INVENTION

1. Cost Efficiency: Reduces electricity costs by optimizing grid usage, leveraging off-peak energy, and integrating renewable energy sources.
2. Grid Stability: Mitigates the impact of EV charging on the grid by using bulk storage for peak shaving, trickle charging, and excess energy utilization.
3. Scalability: Suitable for small to large-scale charging station deployments.
4. Environmental Impact: Enhances the use of renewable energy by integrating solar, wind, and hydroelectric energy into the optimization model.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that is issued therefrom.

1. An electric vehicle charging system comprising:
a bulk battery for storing an electrical charge;
a processor for controlling charging of the bulk battery;
a plurality of electric vehicle charging stations connected to the battery; and an electrical utility grid connected to the battery.

2. The electric vehicle charging system of claim 1, further comprising:
an electric vehicle charging station, wherein the processor controls energy supplied to the electric vehicle charging station for charging a vehicle.

3. The electric vehicle charging system of claim 1, further comprising: a trickle charge power source connected to the bulk battery; and
a time of day charging power source connected to the bulk battery.

4. The electric vehicle charging system of claim 3, further comprising: a charging time optimizer connected to the bulk battery.

5. The electric vehicle charging system of claim 4, further comprising:
a linear program connected to s trickle charger, s time of day charger, the charging time optimizer and the electric vehicle charging station.

6. The electric vehicle charging system of claim 1, wherein the battery is buried underground.

7. A system for optimizing energy utilization in electric vehicle charging stations, comprising an underground bulk battery, a charging management controller processor, and a linear programming model for energy allocation and scheduling for charging the bulk battery; and
energy sources for charging the bulk battery, the energy sources comprising trickle charging the bulk battery from an electrical utility grid during off-peak hours to reduce overall operational costs.

8. The system of claim 7 further wherein the linear programming model controls energy supplied to the electric vehicle charging station while charging the electrical vehicle.

9. A method for minimizing operational costs of EV charging stations, the method compnsmg:
determining optimal charging sources and charging schedules;
managing energy flow between an electrical utility grid, excess bulk battery storage, and charging stations using a linear programming model; and
maintaining operational constraints, comprising grid capacity, excess bulk battery storage, time of day charging, trickle charging and electrical vehicle charging at the electrical charging station.

10. The method of claim 9 further comprising:
trickle charging the bulk battery from the electrical utility grid during off-peak hours to reduce overall operational costs.

11. The method of claim 9 further comprising: managing excess renewable energy by directing it to charge the bulk battery storage during high production periods.

12. The method of claim 9 further comprising: utilizing excess bulk battery energy to directly power electric vehicle charging stations, reducing grid dependency during high demand.
